(19) United States
(12) Patent Application Publication
(10) Pub. No.: US 2021/0132350 A1
(43) Pub. Date: May 6, 2021

(54) METHOD AND APPARATUS FOR EXTENDING DEPTH OF FIELD DURING FLUORESCENCE MICROSCOPY IMAGING

(71) Applicant: The Regents of the University of California, Oakland, CA (US)

(72) Inventors: Farzad Fereidouni, Sacramento, CA (US); Richard M. Levenson, Davis, CA (US)

(73) Assignee: The Regents of the University of California, Oakland, CA (US)

(21) Appl. No.: 16/962,825

(22) PCT Filed: Jan. 28, 2019
(86) PCT No.: PCT/US19/15485

§ 371 Date: Jul. 16, 2020

Related U.S. Application Data
(60) Provisional application No. 62/623,320, filed on Jan. 29, 2018.

(51) Int. Cl. G02B 21/00; G01N 21/64; G06T 5/00; G06T 5/50; G06T 3/40

(52) U.S. Cl. CPC G02B 21/008; G01N 21/6458; G02B 21/0036; G02B 21/0076; G02B 21/0032; G02B 21/006; G06T 2207/20056; G06T 5/50; G06T 3/4015; G06T 2207/10024; G06T 2207/10056; G06T 2207/10064; G06T 2207/20221; G06T 5/003

(57) ABSTRACT

The disclosed embodiments relate to a system that performs microscopy imaging with an extended depth of field. This system includes a stage for holding a sample, and a light source for illuminating the sample, wherein the light source produces ultraviolet light with a wavelength in the 230 nm to 300 nm range to facilitate microscopy with ultraviolet surface excitation (MUSE) imaging. The system also includes an imaging device, comprising an objective that magnifies the illuminated sample, and a sensor array that captures a single image of the magnified sample. The system also includes a controller, which controls the imaging device and/or the stage to scan a range of focal planes for the sample during an acquisition time for the single image. The system additionally includes an image-processing system, which processes the single image using a deconvolution technique to produce a final image with an extended depth of field.

### RELATED APPLICATION

This application claims priority under 35 U.S.C. § 119 to U.S. Provisional Application No. 62/623,320, entitled “Method for Extending Depth of Field for Microscopy Imaging” by the same inventors as the instant application, filed on 29 Jan. 2018, the contents of which are incorporated by reference herein.

### BACKGROUND

### Field

The disclosed embodiments relate to techniques for performing fluorescence microscopy imaging. More specifically, the disclosed embodiments relate to techniques for increasing the depth of field for images acquired through fluorescent microscopy imaging.

### Related Art

To facilitate high resolution in fluorescence microscopy, high numerical aperture (NA) lenses are typically used to acquire the images. Unfortunately, the use of high NA lenses significantly limits the depth of the field of the microscope, which means that only features within an extremely thin focal plane will be in focus, while other features that are not located in the focal plane will be out of focus. For thin-sectioned microscopy slides, this is typically not a problem due to the almost flat topography of the tissue mounted on the glass slide. However, this limited depth of field becomes a problem while imaging non-sectioned tissue sitting on the imaging plane of the microscope. This is due to the extent of tissue surface roughness at a microscopic scale, which makes it almost impossible to have all important features simultaneously in focus.

Researchers have attempted to solve this limited depth of field problem by varying the focus of an imaging device (or varying the distance of the sample from the imaging device) while the image is being acquired so that information is gathered from a number of different imaging planes. The resulting blurry image is then processed through deconvolution to produce a final image, which is in focus across a range of depths of field. (For example, see U.S. Pat. No. 7,444,014, entitled “Extended Depth of Focus Microscopy.” by inventors Michael E. Dresser, et al., issued 28 Oct. 2008.) Unfortunately, this technique requires a significant amount of computation to determine the location of objects in the z dimension, which makes it impractical for a wide range of applications.

Hence, what is needed is a technique for extending the depth of field during high-resolution fluorescence microscopy imaging without the performance problems of existing techniques.

### SUMMARY

The disclosed embodiments relate to a system that performs microscopy imaging with an extended depth of field. This system includes a stage for holding a sample, and a light source for illuminating the sample, wherein the light source produces ultraviolet light with a wavelength in the 230 nm to 300 nm range to facilitate microscopy with ultraviolet surface excitation (MUSE) imaging. The system also includes an imaging device, comprising an objective that magnifies the illuminated sample, and a sensor array that captures a single image of the magnified sample. The system also includes a controller, which controls the imaging device and/or the stage to scan a range of focal planes for the sample during an acquisition time for the single image. The system additionally includes an image-processing system, which processes the single image using a deconvolution technique to produce a final image with an extended depth of field.

In some embodiments, while scanning the range of focal planes for the sample, the system uses a tunable lens to vary a focus of the imaging device.

In some embodiments, scanning the range of focal planes for the sample involves moving one or more of the following: the sample; the objective; a tube lens, which is incorporated into the imaging device; and the sensor array.

In some embodiments, moving one or more of the sample, the objective, the tube lens or the sensor involves using one or more of: a piezoelectric actuator; a linear actuator, and a voice coil.

In some embodiments, capturing the single image of the sample involves: capturing multiple images of the sample; and combining the multiple images to produce the single image of the sample.

In some embodiments, processing the single image comprises: applying the deconvolution technique to multiple color planes of the single image acquired with a sensor with Bayer pattern separately to produce multiple deconvolved color planes; and combining the multiple deconvolved color planes to produce the final image with the extended depth of field.

In some embodiments, processing the single image involves using a two-dimensional (2D) deconvolution.

In some embodiments, the 2D deconvolution comprises a Fourier-transform-based deconvolution.

In some embodiments, the image-processing system additionally uses a machine-learning-based noise-reduction technique and/or resolution-enhancing technique while producing the final image.

In some embodiments, the machine-learning-based noise-reduction and/or resolution-enhancing technique involves creating mappings between deconvolved images and ground-truth images.

In some embodiments, the sample was previously stained using one or more fluorescent dyes.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates a microscopy system that captures an image of a sample while varying the distance between the sample and the imaging device in accordance with the disclosed embodiments.

FIG. 2 illustrates a microscopy system that captures an image of a sample while varying the focal distance to the sample in accordance with the disclosed embodiments.

FIG. 3 presents a flow chart illustrating a process for capturing and processing an image in a manner that facilitates extending the depth of field of the image in accordance with the disclosed embodiments.

FIG. 4 illustrates how images can be improved through extended depth of field (EDOF) techniques in accordance with the disclosed embodiments.

FIG. 5 presents a flow chart for a process that separately deconvolves color planes for the captured image and then combines the deconvolved images in accordance with the disclosed embodiments.

FIG. 6 illustrates how exemplary images for different color components can be separately deconvolved before being combined in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules. The methods and processes described in the detailed description section can be embodied as code and/or data, which can be stored in a computer-readable storage medium as described above.

### Discussion

MUSE (Microscopy with UV Surface Excitation) is a new approach to microscopy, which provides a straightforward and inexpensive imaging technique that produces diagnostic-quality images, with enhanced spatial and color information, directly and quickly from fresh or fixed tissue. The imaging process is non-destructive, permitting downstream molecular analyses. (See Farzad Fereidouni, et al., “Microscopy with UV Surface Excitation (MUSE) for slide-free histology and pathology imaging,” Proc. SPIE 9318, Optical Biopsy XIII: Toward Real-Time Spectroscopic Imaging and Diagnosis, 93180F, 11 Mar. 2015.)

To facilitate MUSE imaging, samples are briefly stained with common fluorescent dyes, followed by 280 nm UV light excitation that generates highly surface-weighted images due to the limited penetration depth of light at this wavelength. This method also takes advantage of the “USELESS” phenomenon (UV stain excitation with long emission Stokes shift) for broad-spectrum image generation in the visible range. Note that MUSE readily provides surface topography information even in single snapshots, and while not fully three-dimensional, the images are easy to acquire, and easy to interpret, providing more insight into tissue structure.

Unfortunately, working with samples with intrinsic depth information can pose problems with respect to determining appropriate focal points as well as capturing extended depth-of-field images. We have developed an accelerated and efficient technique for extending depth of field during MUSE imaging by employing swept-focus acquisition techniques. We have also developed a new method for rapid autofocus. Together, these capabilities contribute to MUSE functionality and ease of use.

Because MUSE operates by performing wide-field fluorescence imaging of tissue using short ultraviolet (UV) light (typically 280 nm) excitation. MUSE techniques can only image the surface of a thick specimen. The fact that objects inside the tissue are not visualized by MUSE allows the computational operations required to capture extended depths of focus to omit computationally intensive operations required by previous approaches to this problem. (Note that MUSE is the only wide-field UV imaging technique that captures an image instantaneously with only surface-weighted features.)

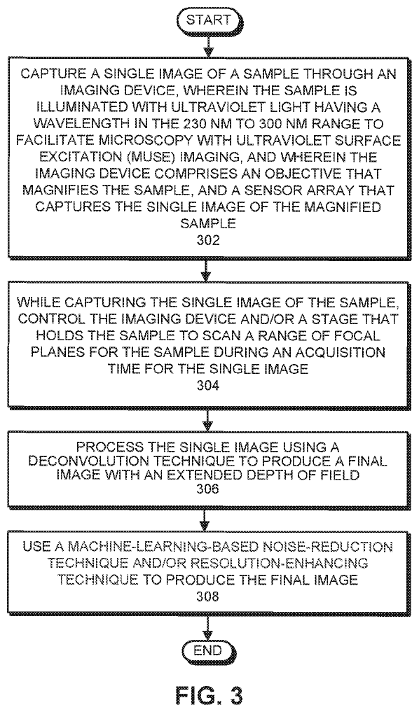

Previous techniques for capturing a single image while varying the z-axis position of focus required an object-estimation step as part of the extended depth of field (EDOF) computation, because those non-surface weighted imaging methods obtained multiple signals at different depths within the imaged volume. For example, see step 310 in the flow chart in FIG. 3 of U.S. Pat. No. 7,444,014 (cited above). In contrast, our new MUSE EDOF technique only detects emitting objects located along the specimen surface, which may or may not be flat. This allows the computationally expensive “object-estimation step” described in U.S. Pat. No. 7,444,014 to be omitted.

### Advantages

Our new MUSE EDOF imaging technique provides a number of advantages.

(1) The technique is compatible with conventional microscope designs. Only minor alterations of a conventional microscope design are required. These alterations can involve assembling the microscope objective on a piezoelectric actuator (or using other mechanical stages) so that a focal plane scanning operation can be synchronized with image acquisition by the camera.

(2) No extra data or image acquisition is required. Thanks to the rapid response of a piezoelectric actuator, the image acquisition time is not extended during the EDOF image-acquisition process.

(3) This technique facilitates near-real-time analysis. During operation, the piezoelectric actuator (or other mechanical device) is configured to move the microscope stage or objective into a desired range (˜100 μm) within the acquisition time of the camera to capture a single image. This technique scans the desired range in a synchronized way with the camera and collects light from all of the layers. By using this image-acquisition technique, we essentially integrate the three-dimensional (3D) profile of the object convoluted with a 3D point spread function (PSF) into a two-dimensional (2D) image. According to the convolution theorem, the integration on z-direction drops out of the convolution and it turns into an object convoluted with a 2D PSF. Hence, the method of analysis is basically a 2D deconvolution of the image. Note that there exist a large number of available methods to perform 2D convolution. However, because of time constraints we have focused on Fourier-transform-based techniques.

(4) The technique also facilitates noise reduction. Although the PSF-based deconvolutions are effective, they add variable amounts of noise to the resulting image. To reduce this noise, we can use a machine-learning-based noise reduction technique, which operates by creating mappings between deconvolved images and “ground-truth” EDOF images obtained using multiple individual planes. These can be combined into a single EDOF image with much lower noise, but at the cost of multiple image acquisitions and very long computational times. Note that using the machine-learning-based mappings (on a sample-type-to-sample-type basis) allows us to acquire rapid, single-image swept-focus images, and to compute a high-quality, low-noise resulting image. Noise reduction can also be accomplished by applying custom window functions on Fourier transformed images to suppress low signal high frequency components. (See for example “Optical Systems with Resolving Powers Exceeding the Classical Limit,” JOSA Vol. 56, Issue 11, pp. 1463-1471.1966.) This technique provides real-time noise reduction because it is simply includes multiplying the window function to the Fourier transformed image. Yet another noise-reduction technique is standard Weiner filtering. (See Wiener, Norbert, 1949, Extrapolation. Interpolation, and Smoothing of Stationary Time Series. New York: Wiley.)

A major benefit of this technique is speed. Note that the image-acquisition time is not limited by the scanning because the scanning operation is synchronized by camera exposure time. Moreover, because the collected data is limited, the associated analysis technique does not require data from multiple layers.

### Microscopy System

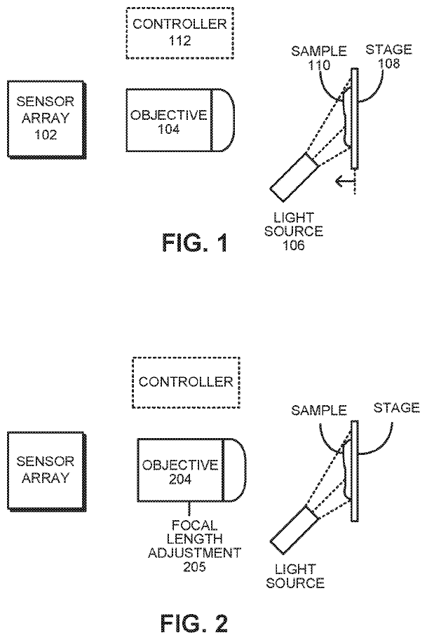

FIG. 1 illustrates an exemplary microscopy system that captures an image of a sample 110 while varying the distance between the sample and the imaging device in accordance with the disclosed embodiments. More specifically, FIG. 1 illustrates an imaging device, which is comprised of a sensor array 102 and an objective 104. This imaging device acquires an image of a sample 110, which is affixed to a movable stage 108. During the imaging process, a light source 106 illuminates the sample 110 with UV light, which has a wavelength of 280 nm to facilitate MUSE imaging. Note that all of the components illustrated in FIG. 1 are operated by a controller 112.

Because stage 108 is movable, it is possible to synchronize the movement of the focal plane through the sample 110 with the gathering of the image by sensor array 102. For example, stage 108 can be used to move the sample 110 toward the objective 104 one micron per millisecond in a 100 ms window, during which sensor array 102 gathers the image. (In an alternative embodiment, objective 104 and/or sensor array 102 can be moved instead of stage 108.) Also, we can employ any type of linear actuator, such as a piezoelectric transducer or a voice coil, to move stage 108.

Note that it is not practical to gather the image for much longer than the time which would saturate the imaging device, so we can only gather a limited amount of light for each focal plane. To remedy this problem, we can take more images and then average them.

FIG. 2 illustrates an alternative design for a microscopy system, which uses an objective 204 that changes its focal length to move the focal plane instead of using a movable stage. As illustrated in FIG. 2, objective 204 includes a focal length adjustment 205, which can be used to change the position of the focal plane.

### Capturing and Processing an Image

FIG. 3 presents a flow chart illustrating a process for capturing and processing an image in a manner that facilitates extending the depth of field of the image in accordance with the disclosed embodiments. During operation, the system captures a single image of a sample through an imaging device, wherein the sample is illuminated with ultraviolet light having a wavelength in the 230 nm to 300 nm range to facilitate microscopy with ultraviolet surface excitation (MUSE) imaging, and wherein the imaging device comprises an objective that magnifies the sample, and a sensor array that captures the single image of the magnified sample (step 302). While capturing the single image of the sample, the system controls the imaging device and/or a stage that holds the sample to scan a range of focal planes for the sample during an acquisition time for the single image (step 304). Next, system processes the single image using a deconvolution technique to produce a final image with an extended depth of field (step 306). Finally, the system optionally uses a machine-learning-based noise-reduction technique and/or resolution-enhancing technique to produce the final image (step 308). For example, the system can use a machine-learning technique, such as generative adversarial networks (GANs).

During processing step 306, we assume that by summation of the image layer over the axial axis, the convolution on the z-axis drops out and we have the summation of the objects convoluted with sum of the PSF.

For a 3D object, the image from different axial layers is determined by convolving the 3D PSF with the object profile:

I(x,y,z)=O(x,y,z)⊗PSF(x,y,z) (1)

by defining the accumulated intensity as

$${\int }_{- Z}^{Z} I ( x , y , z ) dz = {I}_{a} ( x , y ) ,$$

and the accumulated PSF as

$${\int }_{- Z}^{Z} PSF ( x , y , z ) dz = {PSF}_{a} ( x , y ) ,$$

and assuming that the light comes from the surface layer only

$${\int }_{- Z}^{Z} O ( x , y , z ) dz = O ( x , y ) ,$$

we can take the integral of both sides of Eq. (1) over the axial axis:

Iₐ(x,y)=O(x,z)⊗PSFₐ(x,y) (2),

and can recover the object by applying a deconvolution filter of PSF_{c}(x,y):

O(x,y)=I_{c}(x,y)⊗⁻¹PSF_{c}(x,y) (3).

For near-real-time processing, methods based on inverse Fourier transforms will be acceptable. In these methods, the summed image is Fourier-transformed and divided by the OTF (the Fourier transformation of the PSF) to deconvolve the summed PSF from the blurred image. While fast, these FFT-based methods are unfortunately noisy and require appropriate noise suppression, such as through Weiner filtering. By using a fast method for performing the Fourier transformation, such as the method used by the Fastest Fourier Transform in the West (FFTW) software library developed by Matteo Frigo and Steven G. Johnson at the Massachusetts Institute of Technology, an EDOF for a 9 megapixel image can be returned within a second.

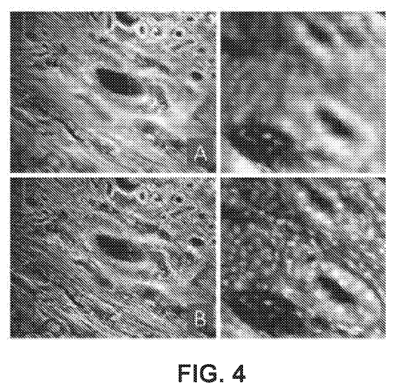

As illustrated by the images that appear in FIG. 4, by using the above-described EDOF processing technique, we are able to effectively reconstruct a completely focused image, starting with a sample with considerable surface roughness. FIG. 4 illustrates images of a kidney sample stained with rhodamine and Hoechst. The right column in FIG. 4 illustrates a zoomed-in region from the red square in left column.

Note that the extended surface topography of the kidney sample, which comprises thick tissues, makes it hard to obtain in-focus images, even using a conventional autofocus, as illustrated in Row A, wherein a single image is taken at optimal focus. In contrast, row B illustrates a much clearer, deconvolved through-focus single image, and row C illustrates a deconvolved average of a 10-frame z-stack. Note that while the images in row C, which are constructed from multiple z-planes, display much less noisy in-focus images than in row B, it takes almost 10 times longer to acquire these images, and longer still to process the multiple z-plane images. Our goal is to achieve the quality of row C within the time it takes to acquire and process the data in row B.

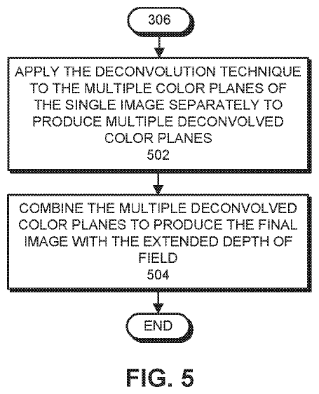

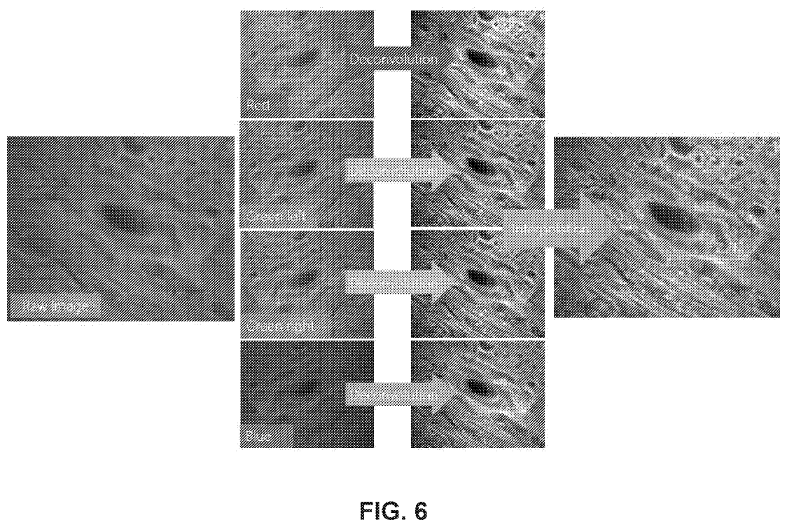

FIG. 5 presents a flow chart of a process that separately deconvolves color planes for the captured image and then combines the deconvolved images in accordance with the disclosed embodiments. (This flow chart highlights operations that take place in step 306 in the flow chart that appears in FIG. 3.) While processing the single image in step 306, the system applies the deconvolution technique to multiple color planes of the single image separately to produce multiple deconvolved color planes (step 502). The system then combines the multiple deconvolved color planes to produce the final image with the extended depth of field (step 504). FIG. 6 presents an example illustrating how images for different color components from a Bayer sensor can be separately deconvolved before being combined in accordance with the disclosed embodiments.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A system for performing microscopy imaging with an extended depth of field, comprising:
a stage for holding a sample;
a light source for illuminating the sample, wherein the light source produces ultraviolet light with a wavelength in the 230 nm to 300 nm range to facilitate microscopy with ultraviolet surface excitation (MUSE) imaging;
an imaging device, comprising,
an objective that magnifies the illuminated sample, and
a sensor array that captures a single image of the magnified sample;
a controller, which controls the imaging device and/or the stage to scan a range of focal planes for the sample during an acquisition time for the single image; and
an image-processing system, which processes the single image using a deconvolution technique to produce a final image with an extended depth of field.

2. The system of claim 1, wherein while scanning the range of focal planes for the sample, the system uses a tunable lens to vary a focus of the imaging device.

3. The system of claim 1, wherein scanning the range of focal planes for the sample involves moving one or more of the following:
the sample;
the objective;
a tube lens, which is incorporated into the imaging device; and
the sensor array.

4. The system of claim 3, wherein moving one or more of the sample, the objective, the tube lens or the sensor involves using one or more of:
a piezoelectric actuator;
a linear actuator; and
a voice coil.

5. The system of claim 1, wherein capturing the single image of the sample involves:
capturing multiple images of the sample; and
combining the multiple images to produce the single image of the sample.

6. The system of claim 1, wherein processing the single image comprises:
applying the deconvolution technique to multiple color planes of the single image acquired with a sensor with Bayer pattern separately to produce multiple deconvolved color planes; and
combining the multiple deconvolved color planes to produce the final image with the extended depth of field.

7. The system of claim 1, wherein processing the single image involves using a two-dimensional (2D) deconvolution.

8. The system of claim 7, wherein the 2D deconvolution comprises a Fourier-transform-based deconvolution.

9. The system of claim 1, wherein the image-processing system additionally uses a machine-learning-based noise-reduction technique and/or resolution-enhancing technique while producing the final image.

10. The system of claim 9, wherein the machine-learning-based noise-reduction and/or resolution-enhancing technique involves creating mappings between deconvolved images and ground-truth images.

11. The system of claim 1, wherein the sample was previously stained using one or more fluorescent dyes.

12. A method for performing microscopy imaging with an extended depth of field, comprising:
capturing a single image of a sample through an imaging device, wherein the sample is illuminated with ultraviolet light having a wavelength in the 230 nm to 300 nm range to facilitate microscopy with ultraviolet surface excitation (MUSE) imaging, and wherein the imaging device comprises an objective that magnifies the sample, and a sensor array that captures the single image of the magnified sample;
wherein while capturing the single image of the sample, the method controls the imaging device and/or a stage that holds the sample to scan a range of focal planes for the sample during an acquisition time for the single image; and
processing the single image using a deconvolution technique to produce a final image with an extended depth of field.

13. The method of claim 12, wherein while scanning the range of focal planes for the sample, the method uses a tunable lens in the imaging device to vary a focus of the imaging device.

14. The method of claim 12, wherein scanning the range of focal planes for the sample involves moving one or more of the following:
the sample;
the objective;
a tube lens, which is incorporated into the imaging device; and
the sensor array.

15. The method of claim 14, wherein moving one or more of the sample, the objective, the tube lens or the sensor involves using one or more of:
a piezoelectric actuator;
a linear actuator; and
a voice coil.

16. The method of claim 12, wherein capturing the single image of the sample involves:
capturing multiple images of the sample; and
combining the multiple images to produce the single image of the sample.

17. The method of claim 12, wherein processing the single image comprises:
applying the deconvolution technique to multiple color planes of the single image acquired with a sensor with Bayer pattern separately to produce multiple deconvolved color planes; and
combining the multiple deconvolved color planes to produce the final image with the extended depth of field.

18. The method of claim 12, wherein processing the single image involves using a two-dimensional (2D) deconvolution.

19. The method of claim 18, wherein the 2D deconvolution comprises a Fourier-transform-based deconvolution.

20. The method of claim 12, wherein the method further comprises using a machine-learning-based noise-reduction technique and/or resolution-enhancing technique while producing the final image.

21. The method of claim 20, wherein the machine-learning-based noise-reduction and/or resolution-enhancing technique involves creating mappings between deconvolved images and ground-truth images.

22. The method of claim 12, wherein the sample was previously stained using one or more fluorescent dyes.

23. A non-transitory, computer-readable storage medium storing instructions that when executed by a controller for a microscopy imaging system cause the microscopy imaging system to perform a method for microscopy imaging with an extended depth of field, the method comprising:
capturing a single image of a sample through an imaging device, wherein the sample is illuminated with ultraviolet light having a wavelength in the 230 nm to 300 nm range to facilitate microscopy with ultraviolet surface excitation (MUSE) imaging, and wherein the imaging device comprises an objective that magnifies the sample, and a sensor array that captures the single image of the magnified sample;
wherein while capturing the single image of the sample, the method controls the imaging device and/or a stage that holds the sample to scan a range of focal planes for the sample during an acquisition time for the single image; and
processing the single image using a deconvolution technique to produce a final image with an extended depth of field.

24. The non-transitory, computer-readable storage medium of claim 23, wherein while scanning the range of focal planes for the sample, the method uses a tunable lens to vary a focus of the imaging device.

25. The non-transitory, computer-readable storage medium of claim 23, wherein scanning the range of focal planes for the sample involves moving one or more of the following:
the sample;
the objective;
a tube lens, which is incorporated into the imaging device; and
the sensor array.

26. The non-transitory, computer-readable storage medium of claim 25, wherein moving one or more of the sample, the objective, the tube lens or the sensor involves using one or more of:
a piezoelectric actuator;
a linear actuator; and
a voice coil.

27. The non-transitory, computer-readable storage medium of claim 23, wherein capturing the single image of the sample involves:
capturing multiple images of the sample; and
combining the multiple images to produce the single image of the sample.

28. The non-transitory, computer-readable storage medium of claim 23, wherein processing the single image comprises:
applying the deconvolution technique to multiple color planes of the single image acquired with a sensor with Bayer pattern separately to produce multiple deconvolved color planes; and
combining the multiple deconvolved color planes to produce the final image with the extended depth of field.

29. The non-transitory, computer-readable storage medium of claim 23, wherein processing the single image involves using a two-dimensional (2D) deconvolution.

30. The non-transitory, computer-readable storage medium of claim 29, wherein the 2D deconvolution comprises a Fourier-transform-based deconvolution.

31. The non-transitory, computer-readable storage medium of claim 23, wherein the method further comprises using a machine-learning-based noise-reduction technique and/or resolution-enhancing technique while producing the final image.

32. The non-transitory, computer-readable storage medium of claim 31, wherein the machine-learning-based noise-reduction and/or resolution-enhancing technique involves creating mappings between deconvolved images and ground-truth images.

33. The non-transitory, computer-readable storage medium of claim 23, wherein the sample was previously stained using one or more fluorescent dyes.
